(19) United States
(12) Patent Application Publication
(10) Pub. No.: US 2005/0063304 A1
(43) Pub. Date: Mar. 24, 2005

(54) Release timer for NRT connection in mobile communication network

(75) Inventors: Eero Sillasto, Helsinki (FI); Tero Kola, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/968,290

(22) Filed: Oct. 20, 2004

Related U.S. Application Data
(63) Continuation of application No. PCT/FI02/00390, filed on May 7, 2002.

(51) Int. Cl. H04L 12/26

(52) U.S. Cl. 370/229

(57) ABSTRACT

The present invention describes a method, network node and a system for controlling network resources for non real-time data connections in a mobile communication network. Further, the present describes an adaptive inactivity timer, which takes into account the history of the current traffic flow and the nature of the NRT traffic. Traffic must be measured in the mobile communication network for each NRT traffic flow to which the adaptive inactivity timer is used. Specially, the adaptive inactivity timer for the NRT bearers in the WCDMA networks (UTRAN, IP RAN) is concerned. The different NRT traffic protocols, e.g. the TCP, have known transport patterns. The releasing of different resources in mobile communication network can be made dependent of the traffic and on the phase of the transmission. For example, some TCP/IP traffic has different transmission pattern than the WTP has, and further the TCP/IP has different traffic patters in the beginning of the transmission and after a while.

### FIELD OF THE INVENTION

The present invention relates to mobile telecommunication systems. In particular, the present invention relates to a novel and improved method, network node and system for controlling network resources for non real-time data connections in a mobile communication network.

### BACKGROUND OF THE INVENTION

NRT (Non Real-Time) traffic, e.g. web browsing, WAP (Wireless Application Protocol) transactions and email, has been growing considerably lately. It is assumed that NRT traffic will have a major role in present and coming mobile communication networks.

NRT traffic is transmitted as packets over usually unreliable network. The network can be either a fixed or a wireless one. Because the network is unreliable and weak for congestion, special transport (and transaction) protocols have been designed. The most common protocol examples are TCP (Transmission Control Protocol), and for mobile terminals, WTP (Wireless Transport Protocol).

Mobile wireless communication networks have different characteristics and problems than fixed communication networks. One of the most important aspects is the capacity and resource management. In a mobile communication network capacity is always a problem because it should not be wasted.

On the other hand, users that have been allowed to the mobile communication network should have some service, e.g. guaranteed service. The usual solution to this problem is to reserve needed resources by some method or algorithm. However, if resources are reserved, but not used, the capacity is not used efficiently. A special case is the UTRAN (UMTS Terrestrial Radio Access Network) where the code, power, hardware, etc. must be allocated for bearers. If the reservation lasts too long, it may prohibit other users the use of these resources.

The resource allocation, especially for the NRT traffic, is difficult. The NRT traffic is bursty by its nature. This means that there are periods while the resources are used, and also periods while the resources are not used. It has been very hard to decide when to release the reserved resources.

A simple solution for the reservation is to use a release timer that is set on when inactivity is detected. These timers are commonly known as inactivity timers. An inactivity timer is a timer which sets the maximum duration of a DCH (Dedicated CHannel) allocation after data transfer has ceased. If the inactivity timer expires, the UE (User Equipment) shall release the radio link and move to RACH/FACH (Random Access CHannel; Forward Access CHannel) state. The dedicated channel (DCH) is a downlink or an uplink channel that is used to carry user or control information between the network and the user equipment. The Forward access channel (FACH) is a downlink transport channel that is used to carry control information from the base station to the mobile station. The Random access channel (RACH) is an uplink channel that is used to carry control information from the mobile station. The RACH is always received from the entire cell. An inactivity timer can also be used in the Downlink Shared CHannel (DSCH) wherein multiple users can be time multiplexed. When a user has data to be sent in the DSCH, it can utilise the capacity of the DSCH completely if possible. The usage of the inactivity timer eliminates extra signalling due to the delayed release of radio link.

The timer value is, however, usually set by guessing or some analysis to a predefined value. If more activity is detected before the timer expires, the timer is cancelled. If the timer expires, the resources are released, and the release procedure requires a certain amount of time. However, if the timer value is too small, and a user would have had more data to be sent, the resources are released too soon. For example, between packets during a web page downloading. Also the reallocation of the resources takes some time. Correspondingly, if the timer value is set too big, the resources are reserved for nothing.

The UTRAN and IP-RAN (Internet Protocol Radio Access Network) comprise release timers (inactivity timers) for the NRT bearers. However, the timers have predefined values as described above. The reservation of resources is far from accurate. The resources cannot be reserved long for nothing.

### SUMMARY OF THE INVENTION

The present invention describes a method, network node and system for controlling network resources for non real-time data connections in a mobile communication network. In the method radio bearer resources are allocated for non real-time traffic flows. One or more inactivity timer(s) are set on for the radio bearer resources when inactivity is detected on a bearer channel. When an inactivity timer expires, radio bearer resources are released.

The invention describes an adaptive inactivity timer which takes into account the history of the current traffic flow and the nature of the NRT traffic. Traffic must be measured in the network for each NRT traffic flow to which the adaptive timer is used.

Different NRT traffic protocols, e.g. the TCP, and applications have known transport patterns. The releasing of different resources in mobile communication network can be made dependent of the traffic and on the phase of the transmission. For example, some TCP/IP traffic has different transmission pattern than WTP has, and further, the TCP/IP has a different traffic patters in the beginning of the transmission and after a while.

The present UTRAN and IP-RAN comprise release (inactivity) timers for the NRT bearers. However, they use predefined timer values. Therefore, it is hard to decide an appropriate timer value for each network. When adaptive timers are used as the present invention describes, the reservation time will be minimised compared to the predefined timers. Predefined timers are usually too big, because the penalty for releasing resources too early is too high.

The advantage of the present invention is that radio, channel code, network hardware and processing resources are used more effectively if the inactivity timer values are minimised. This means that with the same amount of resources more users can be served. The use of adaptive inactivity timers also enables better Quality of Service (QoS). The QoS weakens with too low inactivity timer values because data channels have to be released and then reallocated.

The present invention has a further advantage. The present invention not only optimises the use of radio resources but also optimises the use and/or allocation of other transport resources. For example, in the UTRAN, AAL2 (ATM Adaptation Layer type 2; ATM, Asynchronous Transfer Mode) resources are allocated based on the radio resource allocations.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates an embodiment of the present invention where an adaptive inactivity timer is used,

FIG. 2 illustrates an embodiment of the present invention where an adaptive inactivity timer is used,

FIG. 3 illustrates an embodiment of the present invention where an adaptive inactivity timer is used,

FIG. 4 illustrates an embodiment of the inactivity timer implementation when one TCP connection is used,

FIG. 5 illustrates an embodiment of the inactivity timer implementation when one TCP connection is used with the FIN flag notification,

FIG. 6 illustrates an embodiment of the inactivity timer implementation when there are different TCP connections in one dedicated channel (DCH),

FIG. 7 illustrates an embodiment of the inactivity timer implementation when there are different TCP connections in one dedicated channel (DCH),

FIG. 8 illustrates an embodiment of the inactivity timer implementation when there are different TCP connections in one dedicated channel (DCH),

FIG. 9 illustrates an embodiment of the inactivity timer implementation when there are different flows inside one TCP connection,

FIG. 10 illustrates an embodiment of the inactivity timer implementation where acknowledgements are ignored, and there is one flow in one TCP connection,

FIG. 11 illustrates an embodiment of the inactivity timer implementation where acknowledgements are ignored, and there are different flows in one TCP connection, and

FIG. 12 illustrates an embodiment of a system in accordance with the present invention.

### DETAILED DESCRIPTION OF THE INVENTION

Reference will now be made in detail to the embodiments of the present invention, examples of which are illustrated in the accompanying drawings.

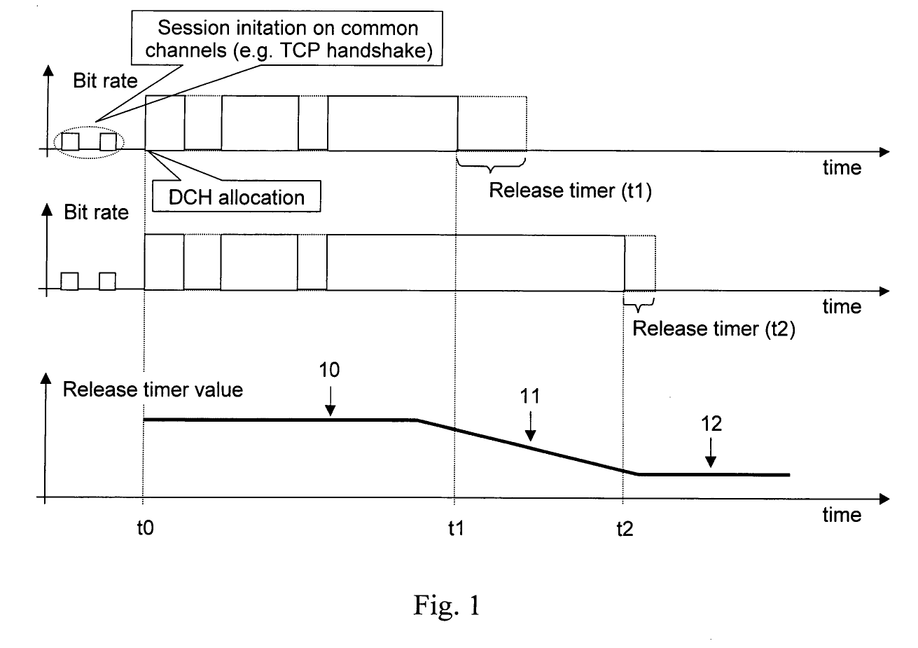

FIG. 1 illustrates an example of an HTTP/TCP session (HTTP, Hyper Text Transport Protocol). A TCP connection establishment is done on common transport channels (three way handshake with headers only i.e. very small packets). A dedicated transport channel (DCH) is allocated when actual data transmission starts. In the beginning, the inactivity timer has higher value (10) since interruptions during the transmission occur because of the TCP slow start algorithm. Therefore, a channel release is not desirable. When a slow start is over, and the channel is fully utilised, the inactivity timer can have a smaller value (11). The inactivity timer value decreases until a minimum value is reached (12). In upper case the release timer is higher at the moment of t1, and in lower case the release timer is lower at the moment of t2.

Transport protocol is a very important piece of information for the inactivity timer value decision. Without it, it is difficult to make accurate value allocation for the inactivity timer. If the application is known, it helps in the decision making. The knowledge of the transport protocol and/or application used can e.g. be acquired by determining the port number used. For example, if the HTTP is used, the network may conclude that user is browsing the web, and there usually are many objects per page and some time in between. The conclusion can for example (based on the magnitude of the risk that resources are released too early) be:
that the resources are released immediately if inactivity is detected and reasonable amount of data is downloaded,
that an inactivity timer value will be set by measurements.

The inactivity timer value can be based simply on the time the resource has been allocated. For example, the longer time, the smaller value. After a long FTP (File Transfer Protocol) session, inactivity is probably a sign that the session is over. The lengths of active and inactive periods (and history of them) will also give extra information for the decision.

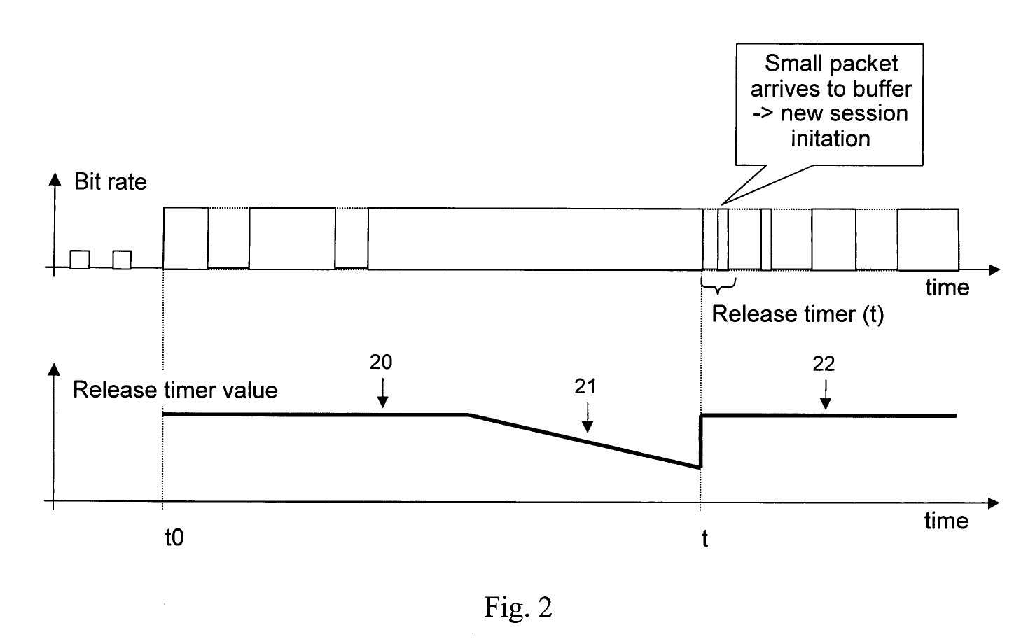

FIG. 2 illustrates an example where the inactivity timer is set to an initial value if a new session is initiated when the inactivity timer is running. A TCP connection establishment is done on common transport channels (three way handshake with headers only i.e. very small packets). A dedicated transport channel (DCH) is allocated when actual data transmission starts. In the beginning, the inactivity timer has a higher value (20) since interruptions during transmission occur because of the TCP slow start algorithm. Therefore, a channel release is not desirable. When the slow start is over, and the channel is fully utilised, the inactivity timer can have a smaller value (21). The meaning of a small packet arrival at a buffer is that a new session is initiated. Therefore, the inactivity timer value is set to the initial value (22).

In FIG. 2, the inactivity timer value is set to the initial value. The TCP session is released by explicit signalling. These messages may, without a proper reason, set the inactivity timer value to a high value, and the reservation of resources would be unnecessary, even if the whole transmission would be over. The distinguishing of the previous sessions' TCP release messages from the new TCP sessions setup messages may be performed as follows:
a) The DL (downlink) packets headers are read and a FIN flag is detected. If the FIN flag is on, i.e. the TCP session is released, the inactivity timer value should not be increased.
b) The inactivity timer value will not be increased, or the inactivity timer cleared, if the incoming packets following a packet with the FIN flag are not bigger than 60 bytes.
c) If an incoming packet is bigger than 60 bytes, the inactivity timer is cleared, and the allocation may continue. The inactivity timer value may be changed for a new or the old TCP session.
d) If the incoming packet has a SYN flag on in the TCP header, the inactivity timer is cleared, and the allocation may continue. If the UL messages are monitored, and the SYN flag in the TCP header is detected, this triggers the clearance of the inactivity timer. Also the DL inactivity timer can be cleared when a SYN flag is detected in UL direction, and vice versa. The inactivity timer value may be changed for a new TCP session.

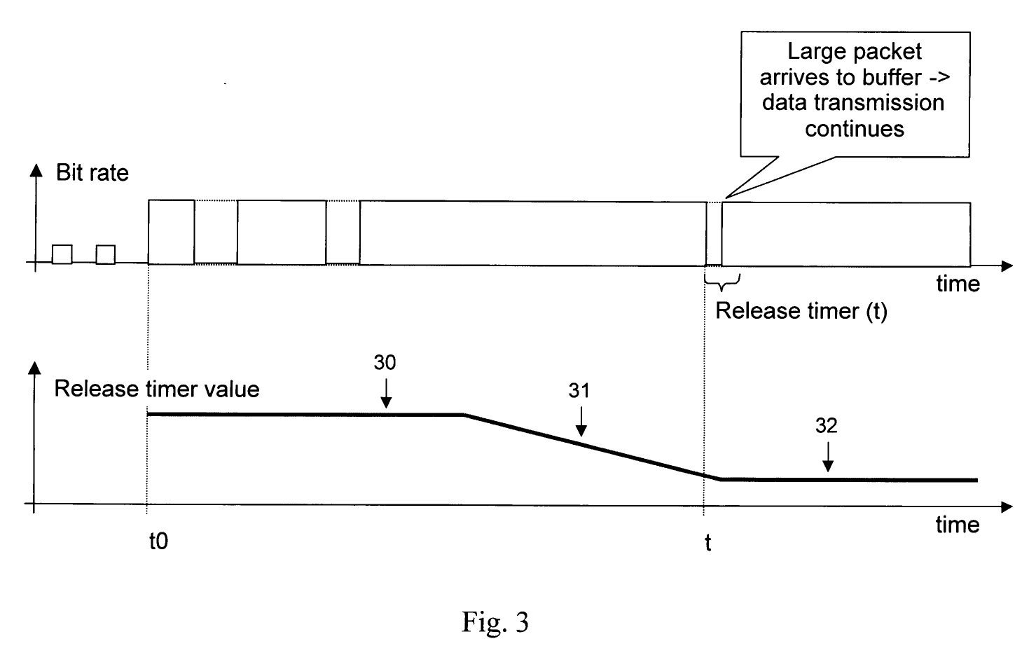

FIG. 3 illustrates an example where the inactivity timer value is not affected when larger packet arrives at a buffer when the inactivity timer is running. A TCP connection establishment is done on common transport channels (three way handshake with headers only i.e. very small packets). A dedicated transport channel (DCH) is allocated when actual data transmission starts. In the beginning, the inactivity timer has a higher value (30) since interruptions during transmission occur because of the TCP slow start algorithm. Therefore, a channel release is not desirable. When the slow start is over, and the channel is fully utilised, the inactivity timer can have a smaller value (31). The inactivity timer value decreases until a minimum value is reached (32). When a large packet arrives at a buffer, the inactivity timer is not affected.

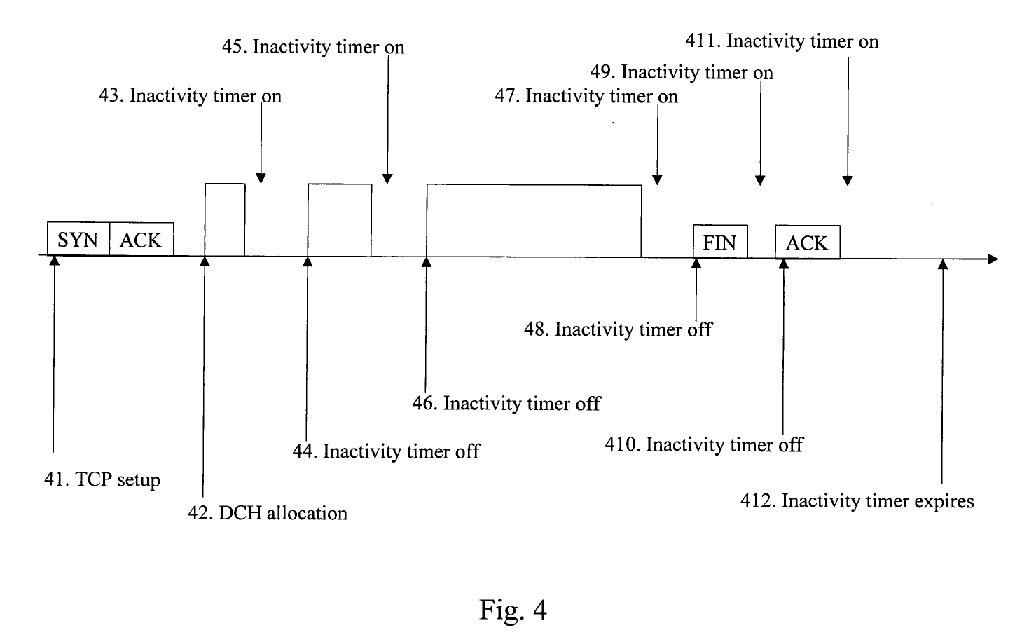

FIG. 4 describes a conventional inactivity timer implementation when using one TCP connection.

FIG. 4 represents a traffic flow when a conventional inactivity timer is implemented and the user happens to download a web page using a TCP connection during this time interval.

The following points are indicated in FIG. 4:
41. A TCP connection is set up. It is assumed here that this occurs on common channels (RACH/FACH), because the connection setup messages are small (order of 40-60 bytes), and the DCH setup is not triggered by so small amounts of user data.
42. The DCH is triggered as the real user data transfer starts and the first packet(s) arrive at the RLC/PDCP buffer (RLC, Radio Link Control). The procedure is not represented here, but it requires explicit signalling, and therefore causes delay.
43. An inactivity timer is set on when the triggering from the MAC (Media Access Control) layer indicates that the buffer is empty. There may be some delay between the actual detection of the emptiness of the buffer and the indication.
44. New data arrives at the buffer and the inactivity timer is cancelled.
45. Inactivity timer is set on. There may be some delay between the actual detection of the emptiness of the buffer and the indication.
46. New data arrives at the buffer and the inactivity timer is cancelled.
47. Inactivity timer is set on. There may be some delay between the actual detection of the emptiness of the buffer and the indication.
48. The inactivity timer is conventionally cancelled. In some cases, a small (probably 40-60 bytes) packet would not cancel the inactivity timer. This would be efficient only when one TCP connection is considered. If there are consecutive TCP connections, the setup of a new TCP connection would not trigger the cancellation of the inactivity timer. This message has a FIN flag, and it is one of the ending messages of a TCP connection. Each side of the TCP connection ends one direction of the TCP connection, so there is a FIN message in uplink and one in downlink directions.
49. The inactivity timer is set on. There may be some delay between the actual detection of the emptiness of the buffer and the indication.
410. New data arrives at the buffer and the inactivity timer is cancelled. This message is to acknowledge to the uplink the FIN message.
411. The inactivity timer is set on. There may be some delay between the actual detection of the emptiness of the buffer and the indication.
412. The inactivity timer expires. The DCH connection ends. If new data arrives at the buffer, a new DCH setup procedure is performed.

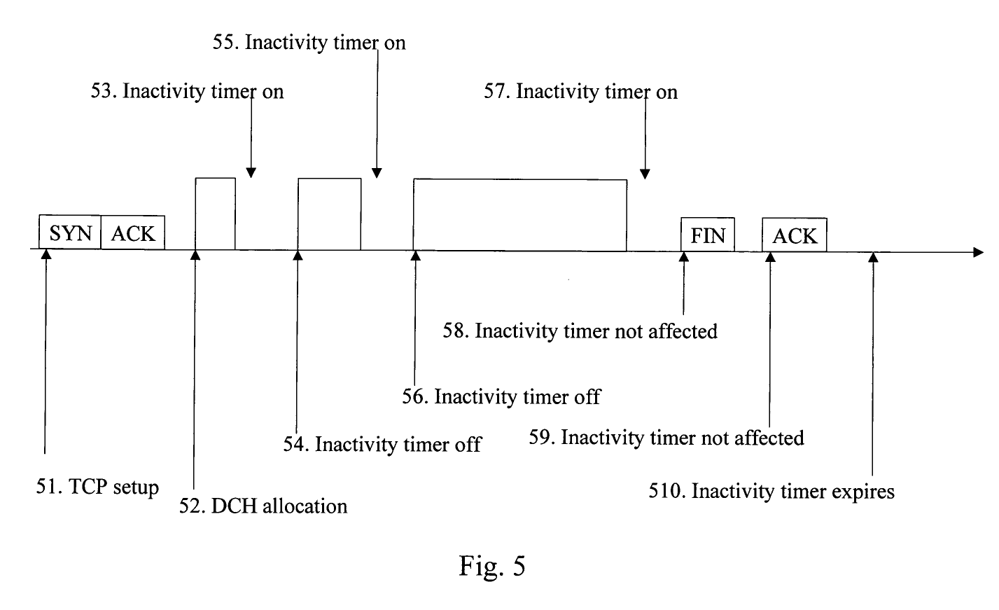

FIG. 5 describes an inactivity timer implementation with a FIN flag notification when using one TCP connection. FIG. 5 represents a traffic flow when a inactivity timer is implemented with a FIN flag notification and the user happens to download a web page using a TCP connection during this time interval.

The following points are indicated in the figure:
51. A TCP connection is set up. It is assumed here that this occurs on common channels (RACH/FACH), because the connection setup messages are small (order of 40-60 bytes) and the DCH setup is not triggered by so small amounts of user data.
52. The DCH is triggered as the real user data transfer starts and the first packet(s) arrive at the RLC/PDCP buffer. The procedure is not represented here, but it requires explicit signalling and, therefore, causes delay.
53. The inactivity timer is set on, when the triggering from the MAC layer indicates that the buffer is empty. There may be some delay between the actual detection of the emptiness of the buffer and the indication.
54. New data arrives at the buffer and the inactivity timer is cancelled.
55. The inactivity timer is set on. There may be some delay between the actual detection of the emptiness of the buffer and the indication.
56. New data arrives at the buffer and the inactivity timer is cancelled.
57. The inactivity timer is set on. There may be some delay between the actual detection of the emptiness of the buffer and the indication.
58. The inactivity timer is not affected, because a FIN flag in the message indicates that this message is an ending message. The inactivity timer is not set/reset when this small packet is sent. In addition, no further small packets (for example, order of 40-60 bytes) can cancel the inactivity timer.
59. The inactivity timer is not affected because there is no user data (or the SYN flag) after the FIN flag detection.
510. The inactivity timer expires. With the same timer value as in the previous case (FIG. 4), the inactivity timer expires quicker.

It must be noted that the functionality of phase 59 can also be different. This is the case e.g. when the uplink direction affects to the downlink functionality. For example, when a FIN flag is sent first in the uplink direction. Therefore, the ACK for the UL FIN may arrive before the DL FIN message, or even that the ACK arrives in the same message than the DL FIN. Therefore, the inactivity timer value in this case may be affected, e.g. it rises.

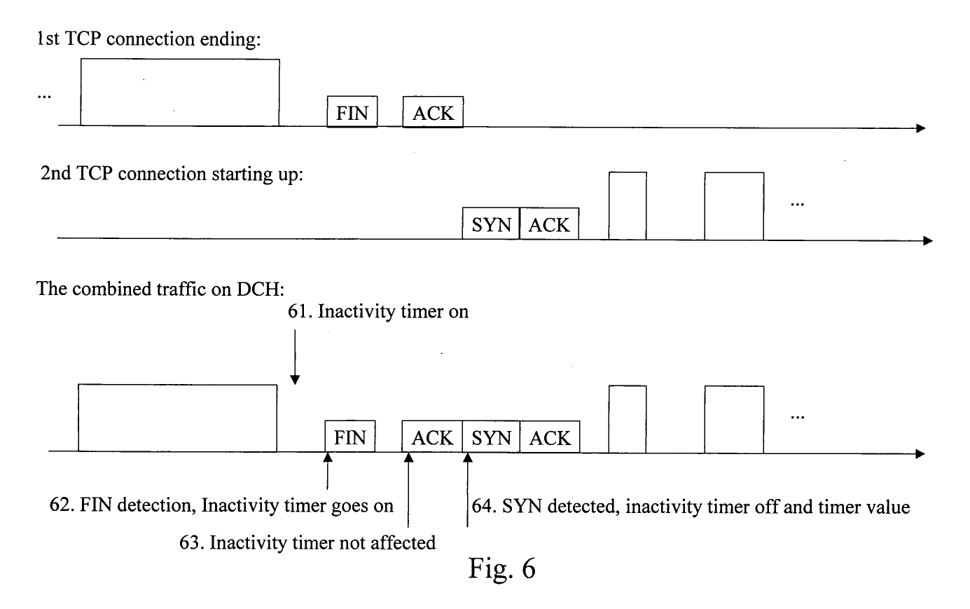

FIGS. 6-8 describe situations where there are different TCP connections in one DCH. One DCH may be the transfer media for many TCP connection traffic flows. These flows may be consecutive or overlapping.

An example of both of these situations may arise when a web page is downloaded with the HTTP1.0. The HTTPv1.0 sets up a TCP connection for each of the objects in the web page. The first TCP connection is set up for the primary object that contains possible links to the other objects. For each of these objects a TCP connection is set up. After the primary object is downloaded, TCP connections are set up to download the secondary objects. The primary object and the first secondary object are consecutive, and the secondary object downloadings may be overlapping.

FIG. 6 describes an inactivity timer implementation with a FIN and SYN detection when there are consecutive TCP connections. In FIG. 6, there are two different TCP connections represented. The following points are indicated in the figure:
61. The inactivity timer is set on, when the triggering from the MAC layer indicates that the buffer is empty. There may be some delay between the actual detection of the emptiness of the buffer and the indication.
62. A FIN flag is detected in a small message. The inactivity timer is neither cancelled nor affected.
63. A small packet arrives. The inactivity timer is not affected because there are no user data or a SYN flag after the FIN flag detection.
64. The SYN flag is on in the packet header. This indicates that a new TCP connection will be set up, and soon a new packet flow shall begin. The inactivity timer is cancelled. The value to be used in future for the next inactive period, may/shall be increased. This is because the new TCP connection has its own slow start, and we expect inactive periods. The DCH connection will remain because the cost of the delay of removing and setting again a new DCH is heavy.

Further course of event for the inactivity timer is not represented here. It behaves like any new TCP connection.

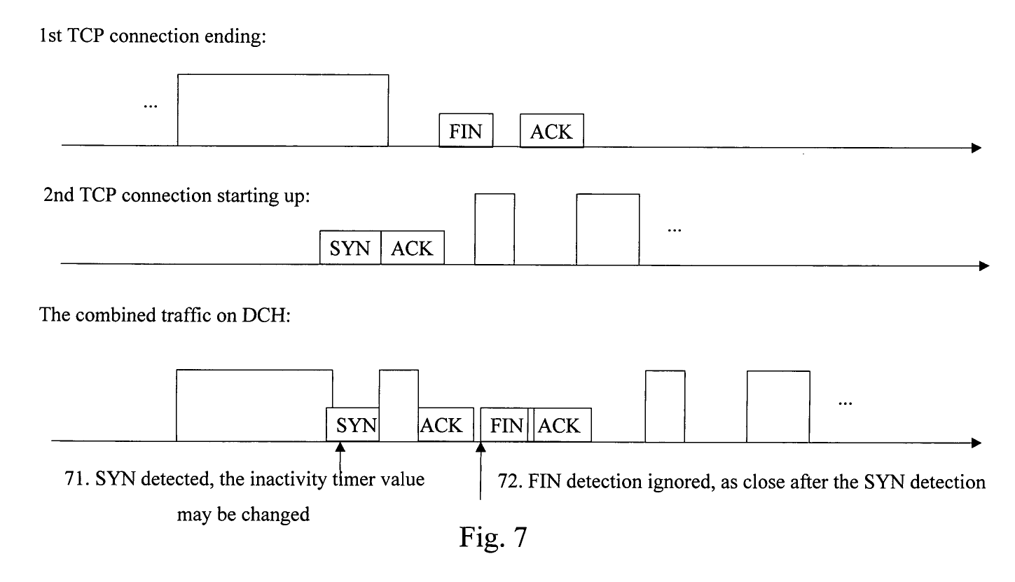

FIG. 7 describes an inactivity timer implementation with a FIN and SYN detection when there are a starting and an ending TCP connection. In FIG. 7, there are two different TCP connections represented. The following points are indicated in the figure:
71. A SYN flag is detected. The inactivity timer value to be used in future may/shall be increased. A new traffic flow is expected to come soon.
72. A FIN flag is detected and ignored. The inactivity timer is not affected. The FIN flag cannot relate to the same connection from which the SYN flag was detected.

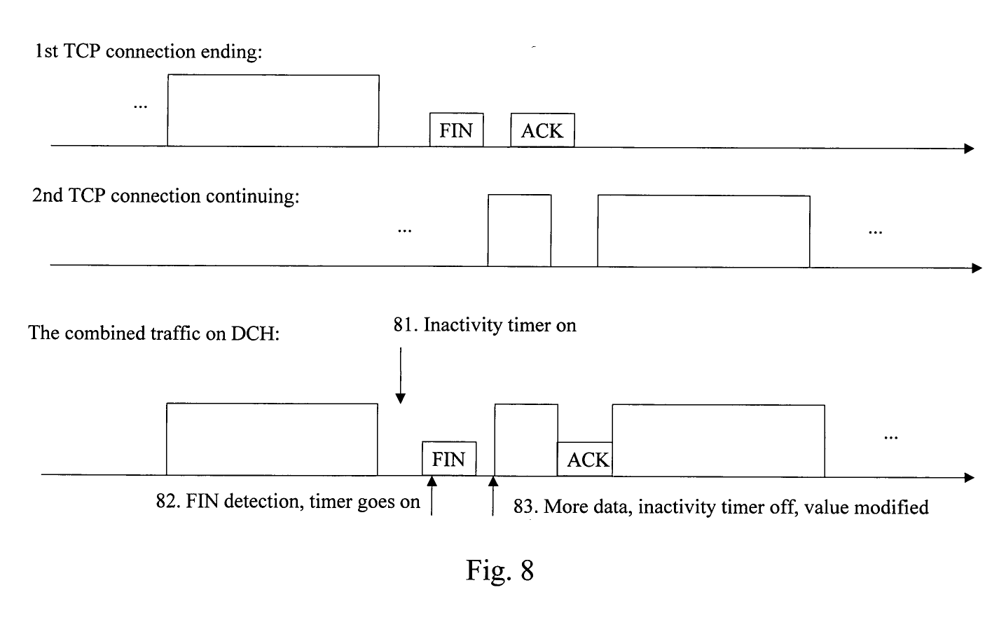

FIG. 8 describes an inactivity timer implementation with FIN and SYN detection when there are two overlapping TCP connections. The following points are indicated in the figure:
81. The inactivity timer is set on, when the triggering from the MAC layer indicates that the buffer is empty. There may be some delay between the actual detection of the emptiness of the buffer and the indication.
82. A FIN flag is detected. The inactivity timer is not affected.
83. User data arrives after the FIN flag detection. The inactivity timer value may/shall be modified. This indicates that even if one TCP connection has terminated, there is/are one/several TCP connection(s) still on.

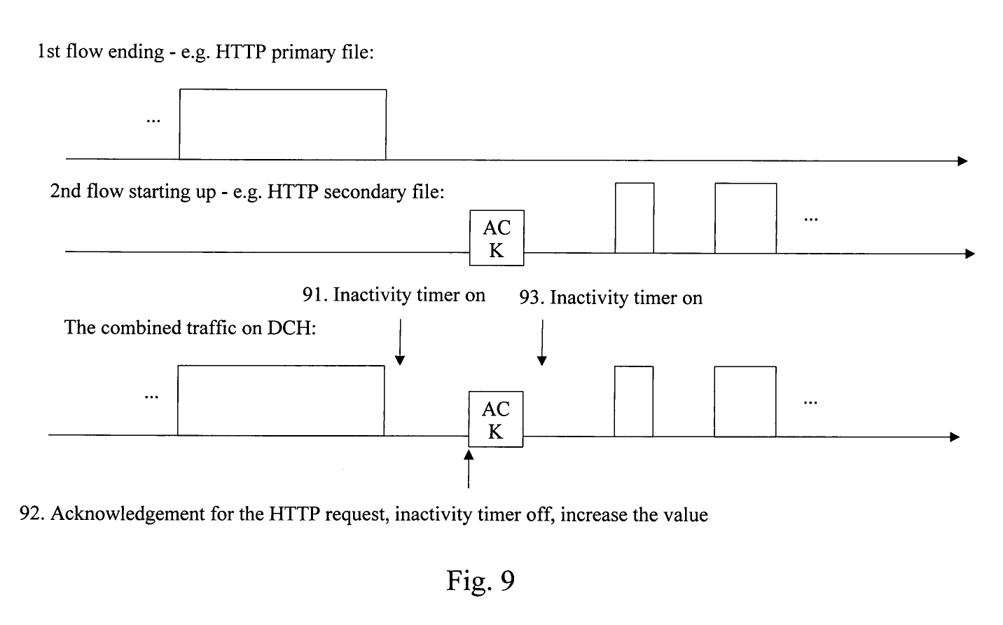

FIG. 9 describes an inactivity timer implementation with a FIN and SYN detection when there are consecutive flows inside one TCP connection. Many different traffic flows may be multiplexed into one TCP connection. This is the case, for example, in the web downloading with the HTTPv1.1

In FIG. 9, there is one TCP connection represented, and two different traffic flows that represent, for example, different objects in the web downloading. The following points are indicated in the figure:
91. The inactivity timer is set on, when the triggering from the MAC layer indicates that the buffer is empty. There may be some delay between the actual detection of the emptiness of the buffer and the indication.
92. A small packet arrives, and the inactivity timer is cancelled. The value for the next inactivity timer is increased. This small message indicates that a new object will be probably downloaded. Therefore, it is wise to increase the inactivity timer value. However, unlike the figure represents, the flow will not experience a slow start because it uses the same TCP connection, which has probably passed already the slow start phase.
93. The inactivity timer is set on, and the transmission continues. There may be some delay between the actual detection of the emptiness of the buffer and the indication.

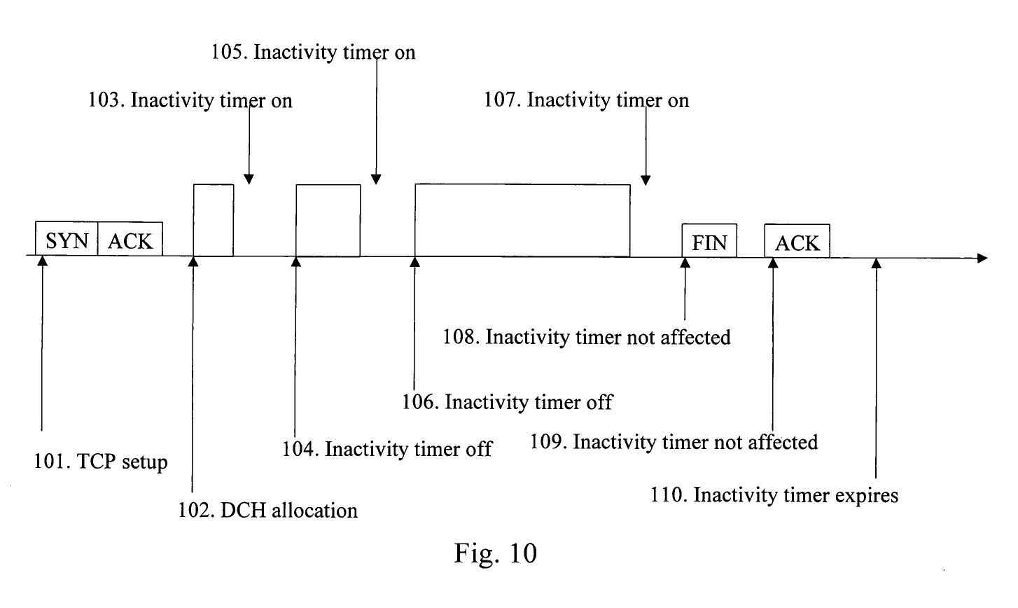

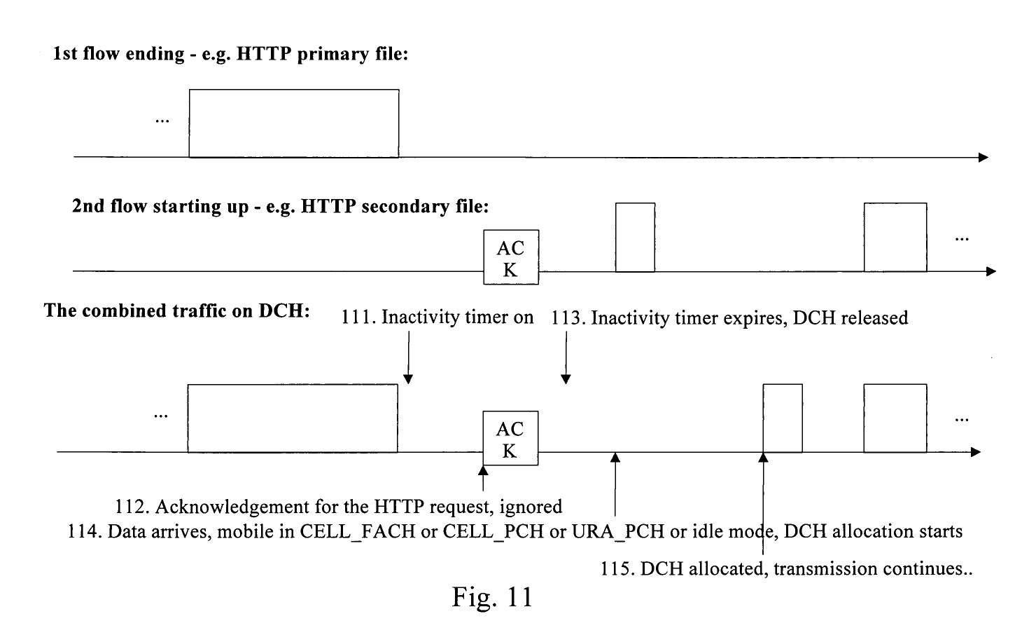

FIGS. 10 and 11 represent situations where acknowledgements are ignored. This kind of implementation is wise only in some specific cases, when one direction of the connection is purely for downloading and the other direction is for acknowledging the arriving data. An example is a basic web downloading.

FIG. 10 describes an inactivity timer implementation where acknowledgements are ignored, and there is one flow in one TCP connection. The following points are indicated in the figure:
101. A TCP connection is set up. It is assumed here that this occurs on common channels (RACH/FACH), because the connection setup messages are small (order of 40-60 bytes) and the DCH setup is not triggered by so small amounts of user data.
102. The DCH is triggered as the real user data transfer starts and the first packet(s) arrive at the RLC/PDCP buffer. The procedure is not represented here, but it requires explicit signalling, and therefore causes delay.
103. The inactivity timer is set on, when the triggering from the MAC layer indicates that the buffer is empty. There may be some delay between the actual detection of the emptiness of the buffer and the indication.
104. New data arrives at the buffer and the inactivity timer is cancelled.
105. The inactivity timer is set on. There may be some delay between the actual detection of the emptiness of the buffer and the indication.
106. New data arrives at the buffer and the inactivity timer is cancelled.
107. The inactivity timer is set on. There may be some delay between the actual detection of the emptiness of the buffer and the indication.
108. The inactivity timer is not affected, because a FIN flag in the message indicates that this message is an ending message. The inactivity timer is not set/reset when this small packet is sent. In addition, no further small packets (for example, order of 40-60 bytes) can cancel the inactivity timer.
109. The inactivity timer is not affected because there is no user data (or a SYN flag) after the FIN flag detection.
110. The inactivity timer expires.

The behaviour of the inactivity timer at the indicated points is the same as in FIG. 5. However, the reasons for the points 108 and 109 are different. In points 108 and 109, the inactivity timer is not affected because the arriving packets are small (size of an acknowledgement, order of 40-60 bytes). In other words, FIG. 10 represents a situation where, for some reason, the content of a small packet (e.g. ACK) is not known. Therefore, in FIG. 10 the size of the packets is used as a criterion for determining whether or not to change the inactivity timer value.

FIG. 11 describes an inactivity timer implementation where acknowledgements are ignored, and there are different flows in one TCP connection. The following points are indicated in the figure:
111. The inactivity timer is set on, when the triggering from the MAC layer indicates that the buffer is empty. There may be some delay between the actual detection of the emptiness of the buffer and the indication.
112. An acknowledgement is ignored.
113. The inactivity timer expires. The DCH is released.
114. More data arrives. A DCH allocation is triggered and proceeded.

A DCH is allocated. The transmission continues.

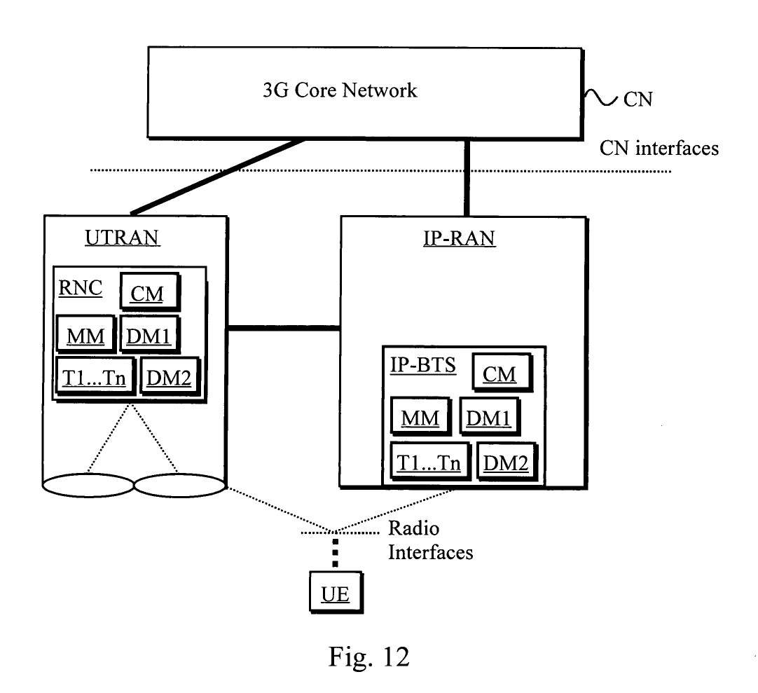

FIG. 12 represents an exemplary embodiment of the system where the present invention can be used. The architecture of FIG. 12 comprises two radio access networks: the UTRAN and the IP-RAN. The IP-RAN (Internet Protocol Radio Access Network) is an RAN architecture that is fully optimised to carry IP traffic and is based on IP transport technology. In the IPRAN, most of the functions of the centralised Radio Network Controller (RNC) are moved to the base station IP-BTS (Internet Protocol Base Station Transceiver). In this configuration the division of functionalities between network elements is fundamentally re-defined to suit the needs of IP traffic. This is clearly different from just using IP as a transport solution with the existing network architectures like the GSM (Global System for Mobile Communications) and the CDMA (Code Division Multiple Access) based radio access networks. The radio access networks are connected to the core network CN.

FIG. 12 comprises also user equipment UE The user equipment UE refers preferably to a mobile terminal, e.g. a mobile phone. The user equipment UE is connected to one or more radio access networks. The network equipment mentioned in the claims preferably refers to the RNC or IP-BTS.

The RNC and IP-BTS comprise one or more inactivity timer(s) T1 . . . Tn for the radio bearer resources for measuring inactivity time. In the present invention, the inactivity timers are adaptive and take into account the history and/or the nature of the traffic flow on the radio bearer resources. The RNC and IP-BTS further comprise means for determining DM1 used non real-time traffic protocol and/or application and means for determining DM2 the adaptive inactivity timer values based on used non real-time traffic protocol and/or application. With means DM1 it is e.g. possible to determine used port number, the port number indicating the traffic protocol and/or the application used. This piece of information can be used in determining the adaptive inactivity timer values. Further, the RNC and IP-BTS comprise means for measuring MM the traffic flows in the mobile communication network, means for determining DM2 the adaptive inactivity timer value(s) based on the measurements and means for clearing CM the inactivity timers T1 . . . Tn. The above-mentioned means are in a preferred embodiment implemented with hardware and/or software components.

In one embodiment of FIG. 12, each dedicated channel has an inactivity timer of its own. Further, in another embodiment of FIG. 12, different adaptive timers are arranged to downlink and uplink directions, and different adaptive timers are arranged for different bit rate channels.

The NRT traffic consists of packets. They must be buffered somewhere in the mobile communication network. In the UTRAN the buffering occurs in the RNC, and in the IP-BTS of the IP-RAN. The buffer length per traffic flow can be monitored. This gives more information for the timer value decision. If for example the buffer has been loaded for some time, for example last five seconds there has been more than five packets all the time in buffer, and the flow has been more or less constant. When an inactivity occurs, then—at least if the TCP is used—the downloading is probably ending, and the resources can be released.

The more information the mobile communication network measures, the more accurate (smaller) timer values may be used. In case of the UTRAN or the IP-RAN, following measurement can be done:
used transport/transaction protocol (by Packet Data Convergence Protocol (PDCP))
used application (by PDCP, e.g. the port numbers from TCP/IP headers)
how long the session has lasted (in time)
lengths of the inactivity and the activity periods (in time)
buffer occupancy history (in bytes or packets)
TCP release messages.

It is obvious to a person skilled in the art that with the advancement of technology, the basic idea of the invention may be implemented in various ways. The invention and its embodiments are thus not limited to the examples described above, instead they may vary within the scope of the claims.

1. A method for controlling network resources for non real-time data connections in a mobile communication network, wherein the method comprises the steps of:
allocating radio bearer resources for non real-time traffic flows;
setting on one or more inactivity timer(s) for said radio bearer resources when inactivity is detected on a bearer channel;
releasing a radio bearer resource when an inactivity timer expires;
characterised in that in the method:
said inactivity timers are adaptive that take into account the history and/or the nature of the traffic flow.

2. The method according to claim 1, characterised in that the method comprises the step of:
decreasing said adaptive inactivity timer starting value as a function of elapsed time since the inactivity started.

3. The method according to claim 1, characterised in that the method comprises the step of:
making use of the transport pattern of a non real-time traffic protocol when determining said adaptive inactivity timer starting value(s).

4. The method according to claim 1, characterised in that the method comprises the step of:
making use of the knowledge of the traffic protocol and/or the application used when determining said adaptive inactivity timer starting value(s).

5. The method according to claim 4, characterised in that said knowledge of the traffic protocol and/or the application is acquired by determining the port number used.

6. The method according to claim 1, characterised in that the method comprises the steps of:
measuring said traffic flows in the mobile communication network; and
determining the inactivity timer starting value(s) based on the measurements.

7. The method according to claim 1, characterised in that each dedicated channel has an adaptive inactivity timer of its own.

8. The method according to claim 1, characterised in that the method comprises the step of:
arranging different adaptive inactivity timers to downlink and uplink directions.

9. The method according to claim 8, characterised in that when adaptive inactivity timer value is cleared in downlink direction, the method comprises the step of:
clearing also the adaptive inactivity timer in uplink direction.

10. The method according to claim 8, characterised in that when adaptive inactivity timer value is cleared in uplink direction, the method comprises the step of:
clearing also the adaptive inactivity timer in downlink direction.

11. The method according to claim 1, characterised in that the method comprises the step of:
determining different adaptive inactivity timers for different bit rate channels.

12. The method according to claim 1, characterised in that the mobile communication network is the UTRAN.

13. The method according to claim 1, characterised in that the mobile communication network is the IP-RAN.

14. A system for controlling network resources for non real-time data connections in a mobile communication network, wherein the system comprises:
user equipment (UE) to which a radio connection is established;
network equipment (NE) for managing and allocating radio bearer resources for non real-time traffic flows;
one or more inactivity timer(s) (T1 . . . Tn) for said radio bearer resources for measuring inactivity time on said radio bearer resources;
characterised in that:
said inactivity timers (T1 . . . Tn) are adaptive that take into account the history and/or the nature of the traffic flow.

15. The system according to claim 14, characterised in that system further comprises:
means for determining (DM1) used non real-time traffic protocol and/or application; and
means for determining (DM2) the adaptive inactivity timer starting values based on used non real-time traffic protocol and/or application.

16. The system according to claim 15, characterised in that system comprises means (DM1) for determining used port number, said port number indicating the traffic protocol and/or the application used.

17. The system according to claim 14, characterised in that the system further comprises:
means for measuring (MM) said traffic flows in the mobile communication network; and
means for determining (DM2) said adaptive inactivity timer starting value(s) based on the measurements.

18. The system according to claim 14, characterised in that each dedicated channel has an adaptive inactivity timer of its own.

19. The system according to claim 14, characterised in that different adaptive inactivity timers (T1 . . . Tn) are arranged to downlink and uplink directions.

20. The system according to claim 14, characterised in that the system comprises means for clearing (CM) said adaptive inactivity timers (T1 . . . Tn).

21. The system according to claim 14, characterised in that different adaptive inactivity timers (T1 . . . Tn) are arranged for different bit rate channels.

22. The system according to claim 14, characterised in that the mobile communication network is the UTRAN.

23. The system according to claim 14, characterised in that the network equipment (NE) refers to the RNC of the UTRAN.

24. The system according to claim 14, characterised in that the mobile communication network is the IP-RAN.

25. The system according to claim 14, characterised in that the network equipment (NE) refers to the IP-BTS of the IP-RAN.

26. A network node for controlling network resources for non real-time data connections in a mobile communication network, wherein the network node is arranged is manage and allocate radio bearer resources for non real-time traffic flows, wherein the network node comprises:
one or more inactivity timer(s) (T1 . . . Tn) for said radio bearer resources for measuring inactivity time on said radio bearer resources;
characterised in that:
said inactivity timers (T1 . . . Tn) are adaptive that take into account the history and/or the nature of the traffic flow.

27. The network node according to claim 26, characterised in that network node further comprises:
means for determining (DM1) used non real-time traffic protocol and/or application; and
means for determining (DM2) the adaptive inactivity timer starting values based on used non real-time traffic protocol and/or application.

28. The network node according to claim 27, characterised in that the network node comprises means (DM1) for determining used port number, said port number indicating the traffic protocol and/or the application used.

29. The network node according to claim 26, characterised in that the network node further comprises:
means for measuring (MM) said traffic flows in the mobile communication network; and
means for determining (DM2) said adaptive inactivity timer starting value(s) based on the measurements.

30. The network node according to claim 26, characterised in that each dedicated channel has an adaptive inactivity timer of its own.

31. The network node according to claim 26, characterised in that different adaptive inactivity timers (T1 . . . Tn) are arranged to downlink and uplink directions.

32. The network node according to claim 26 or 31, characterised in that the network node comprises means for clearing (CM) said adaptive inactivity timers (T1 . . . Tn).

33. The network node according to claim 26, characterised in that different adaptive inactivity timers (T1 . . . Tn) are arranged for different bit rate channels.

34. The network node according to claim 26, characterised in that the mobile communication network is the UTRAN.

35. The network node according to claim 26, characterised in that the network node (NE) refers to the RNC of the UTRAN.

36. The network node according to claim 26, characterised in that the mobile communication network is the IP-RAN.

37. The network node according to claim 26, characterised in that the network node (NE) refers to the IP-BTS of the IP-RAN.
